(19) United States
(12) Patent Application Publication
(10) Pub. No.: US 2003/0107189 A1
(43) Pub. Date: Jun. 12, 2003

(54) Sealing ring for connecting two especially insertable concrete components

(76) Inventors: Roger Bonnert, Loughborough (GB); Fraser Hunt, Loughborough (GB); Paul Willis, Loughborough (GB)

Correspondence Address: Janis K Fraser, Fish & Richardson, 225 Franklin Street, Boston, MA, 02110-2804, US

(21) Appl. No.: 10/203,538

(22) PCT Filed: Feb. 7, 2001
(86) PCT No.: PCT/SE01/00246

(30) Foreign Application Priority Data
Nov. 10, 2000 (SE) 0004110-3

(51) Int. Cl. F16J 15/02

(52) U.S. Cl. 277/647

(57) ABSTRACT

A scaling ring (1) for sealing an annular gap between a concrete pipe socket and a concrete pipe spigot end is adapted to be mounted on a mould ring intended for casting of a concrete pipe comprising a socket so as to be fixed in the socket by said casting. The scaling ring is made in one piece by means of co-extrusion of a soft rubber material and a hard rubber material. The soft rubber material has a hardness of 30-40 IRHD and forms a radially inner sealing layer (6), which is intended to abut against the mould ring during said casting and to abut sealingly against the spigot end during use of the sealing ring (1). The hard rubber material forms a second layer (7) located radially outside the radially inner sealing layer.

### FIELD OF THE INVENTION

The present invention relates to a sealing ring for sealing an annular gap between a concrete pipe socket and a concrete pipe spigot end, said sealing ring being adapted to be mounted on a mould ring intended for casting of a concrete pipe comprising a socket so as to be fixed in the socket by said casting.

### BACKGROUND ART

One problem associated with prior-art sealing rings of this kind, i.e. sealing rings that are intended to be fixed in a concrete pipe socket in connection with the casting thereof, is that the sealing ring moves on the mould ring during casting. Another problem associated with prior-art sealing rings of this kind is that, sometimes, the sealing ring is compressed against the mould ring as a result of the pressure exerted on the sealing ring by the concrete during casting. Such compression may result in the sealing ring assuming an incorrect fixing position in the socket. Another problem found in connection with prior-art sealing rings of this kind is that concrete will penetrate between the sealing ring and the mould ring during casting. In many cases, this concrete will remain stuck to the sealing ring after the form stripping and will, of course, reduce the sealing effect of the sealing ring.

In prior-art sealing rings of this kind, the sealing ring, when being mounted on the mould ring, is stretched out in such a way that it tends to contract after the form stripping, which may lead to the sealing ring coming loose from the socket.

Another problem found when the annular gap that is to be sealed is small and the compression of the sealing ring is great is that fractures may develop in the socket.

### SUMMARY OF THE INVENTION

The object of the present invention is to provide a sealing ring which obviates or at least considerably reduces the above problems.

According to the invention, this object is achieved by means of a sealing ring of the kind described by way of introduction and characterised in that it is made in one piece by means of co-extrusion of a soft rubber material and a hard rubber material, that the soft rubber material has a hardness of 30-40 IRHD and forms a radially inner sealing layer, which is intended to abut against the mould ring during said casting and to abut sealingly against the spigot end during use of the sealing ring, and that the hard rubber material forms a second layer located radially outside the radially inner sealing layer.

In a preferred embodiment, the hard rubber material defines at least one closed cavity in the second layer.

Advantageously, the radial thickness of the sealing ring decreases across at least a portion of its cross-section so as to give the socket a greater wall thickness in its axially inner portion compared with its axially outer portion during said casting.

### BRIEF DESCRIPTION OF THE DRAWINGS

The invention will now be described in more detail with reference to the accompanying drawings.

FIG. 1 is a sectional view of an embodiment of the sealing ring according to the invention.

FIG. 2 is a sectional view of the sealing ring according to FIG. 1 as mounted on a mould ring for casting of a concrete pipe socket.

FIG. 3 is a sectional view of the sealing ring according to FIGS. 1 and 2 as fixed in the concrete pipe socket.

FIGS. 4-6 are sectional views of different embodiments of the sealing ring according to the invention.

### DESCRIPTION OF PREFERRED EMBODIMENTS

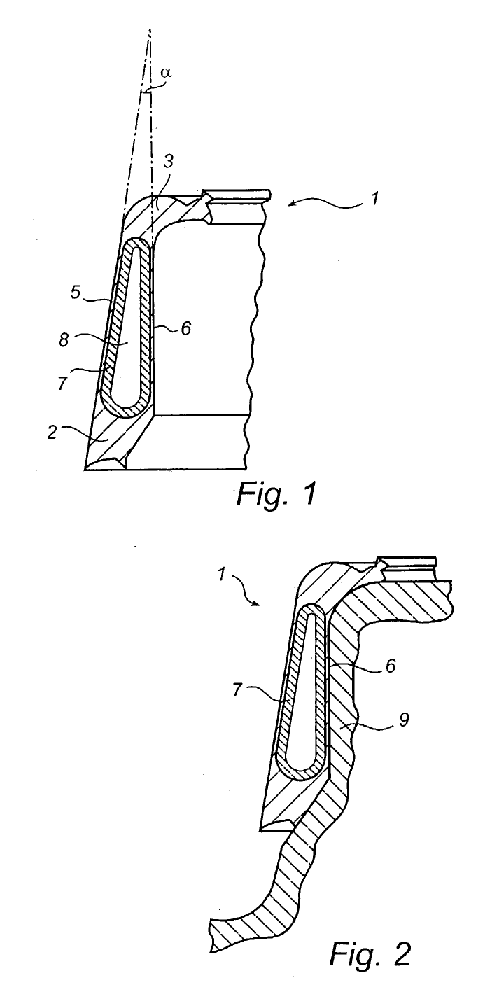

The sealing ring 1 shown in FIGS. 1-3 is made in one piece by means of co-extrusion of a soft rubber material with a hardness of 30-40 IRHD and a hard rubber material with a hardness of 60-80 IRHD. The soft rubber material and the hard rubber material are thus high-quality rubber materials, which according to various standard specifications may be used as sealing material.

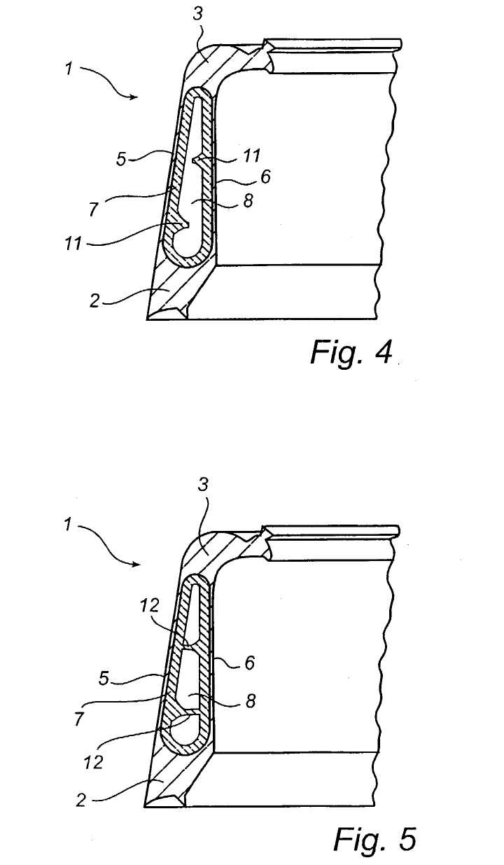

The soft rubber material forms an axially outer sealing portion 2 and an axially inner sealing portion 3. In this connection, ‘axially outer’ and ‘axially inner’ refer to the location of the sealing ring 1 in a concrete pipe socket 4 (see FIG. 3). The soft rubber material further forms a radially outer sealing layer 5 and a radially inner sealing layer 6, which interconnect the portions 2 and 3 and which define, between them, a closed annular cavity, which is filled by a ring 7 of the hard rubber material. The ring 7 of hard rubber material is connected to the ring of soft rubber material formed by the portions 2 and 3 and the layers 5 and 6, and defines an inner cavity 8.

The side of the radially outer layer 5 facing radially outward and the side of the radially inner layer 6 facing radially inward form, between them, an angle α and converge axially inward (relative to the socket 4). Thus, the sealing ring 1 has an axially inwardly decreasing thickness across the main part of its axial extension.

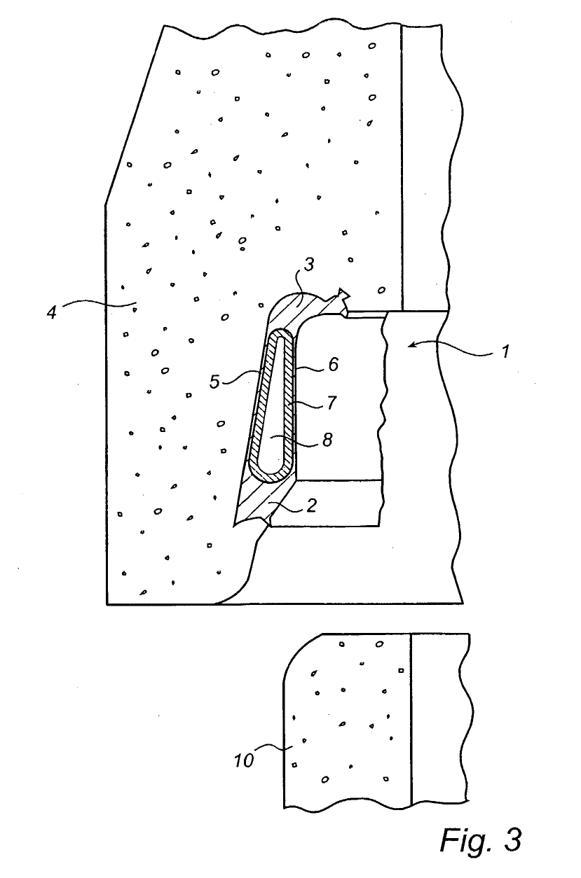

The sealing ring shown in FIG. 2 is mounted on a mould ring 9, which constitutes a bottom mould in a mould for casting a concrete pipe comprising a socket (4) (FIG. 3). As shown, the radially inner sealing layer 6 of soft rubber material abuts against the peripheral surface of the mould ring 9, against which surface it is pressed with relatively great force by the ring 7 of hard rubber material. The sealing ring 1 is thereby kept well in place on the mould ring 9 and does not move thereon when concrete is supplied to the mould to cast the concrete pipe.

FIG. 3 shows a portion of the concrete pipe comprising the socket 4 after the form stripping and with the sealing ring 1 fixed in the socket 4. Owing to the ring 7 of hard rubber material, the sealing ring 1 is kept in a fixed position in the socket 4 and, thus, does not change position when a concrete pipe spigot end 10 is inserted into the socket 4. When the spigot end 10 is inserted into the socket 4, the sealing ring 1 is compressed in the radial direction.

Since the sealing ring 1 has an axially inwardly decreasing thickness, the concrete pipe socket 4 will, during casting, get a larger wall thickness in its axially inner portion compared with its axially outer portion. This reduces the risk of cracking in the concrete.

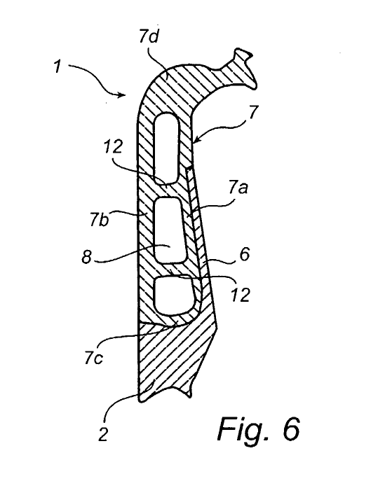

The embodiment shown in FIG. 4 differs from the embodiment shown in FIGS. 1-3 only by the ring 7 of hard rubber material having two circumferential ribs 11, which extend a distance into the cavity 8 and prevent the sealing ring 1 from being completely compressed when the spigot end 10 is being inserted into the socket 4.

The embodiment shown in FIG. 5 differs from the embodiment shown in FIGS. 1-3 only by the ring 7 of hard rubber material having two circumferential, radial beams 12, which interconnect the portions of the ring 7 located on either side of the cavity 8, thereby giving the sealing ring 1 increased stability with regard to the radial compression that occurs when the spigot end 10 is inserted into the socket 4.

Like the embodiments described above, the embodiment shown in FIG. 6 is made in one piece by means of co-extrusion of a soft and a hard high-quality rubber material.

In this context, the soft rubber material forms only an axially outer sealing portion 2 and a radially inner sealing layer 6 connected thereto. The ring 7 of hard rubber material is connected to the ring of soft rubber material formed of the portion 2 and the layer 6. In the embodiment according to FIG. 6, as well as in the embodiments described above, the ring 7 has an inner cavity 8. This cavity 8 is here defined by a radially inner wall 7a, which connects to the radially inner sealing layer 6, a radially outer wall 7b, which replaces the radially outer layer 5 of the embodiments described above, an axially outer portion 7c, which connects to the axially outer sealing portion 2, and an axially inner portion 7d, which replaces the axially inner portion 3 of the embodiments described above. As in the embodiment according to FIG. 5, the inner cavity 8 is here divided into three small cavities by means of two circumferential radial beams 12, which interconnect the walls 7a and 7b.

In the same manner as in the embodiments described above, the sealing ring 1 according to FIG. 6 has an axially inwardly decreasing thickness across the main part of its axial extension, since, as shown, the side of the radially inner layer 6 facing radially inward and the side of the radially outer wall 7b facing radially outward converge axially inward.

1. A sealing ring for sealing an annular gap between a concrete pipe socket (4) and a concrete pipe spigot end (10), said sealing ring (1) being adapted to be mounted on a mould ring (9) intended for casting of a concrete pipe comprising a socket (4) so as to be fixed in the socket by said casting, characterised in
that it is made in one piece by means of co-extrusion of a soft rubber material and a hard rubber material,
that the soft rubber material has a hardness of 30-40 IRHD and forms a radially inner sealing layer (6), which is intended to abut against the mould ring (9) during said casting and to abut sealingly against the spigot end (10) during use of the sealing ring (1), and
that the hard rubber material forms a second layer (7) located radially outside the radially inner sealing layer (6).

2. A sealing ring according to claim 1, in which the hard rubber material defines at least one closed cavity (8) in the second layer (7).

3. A sealing ring according to claim 1 or 2, which, across at least a portion of its cross-section, has a decreasing radial thickness so as to give the socket (4) a greater wall thickness in its axially inner portion compared with its axially outer portion during said casting.
